(19) United States
(12) Patent Application Publication
(10) Pub. No.: US 2014/0129350 A1
(43) Pub. Date: May 8, 2014

(54) ADVERTISEMENT DISTRIBUTION APPARATUS AND ADVERTISEMENT DISTRIBUTION METHOD

(71) Applicant: YAHOO JAPAN CORPORATION, Tokyo (JP)

(72) Inventor: Takashi TASHIRO, Tokyo (JP)

(73) Assignee: YAHOO JAPAN CORPORATION, Tokyo (JP)

(21) Appl. No.: 13/957,822

(22) Filed: Aug. 2, 2013

(30) Foreign Application Priority Data
Nov. 2, 2012 (JP) 2012-242870

(51) Int. Cl. G06Q 30/02

(52) U.S. Cl. CPC G06Q 30/0277
USPC 705/14.71; 705/14.73

(57) ABSTRACT

An advertisement distribution apparatus of the present application includes a storage unit, a calculating unit, a determining unit, and a distributing unit. The storage unit stores a value related to degree of association with content to which advertisement information is allowed to be distributed. The calculating unit calculates degree of association between content and advertisement information upon receiving a distribution request for advertisement information to be distributed to the content. The determining unit determines whether the degree of association calculated by the calculating unit is within a range determined by the value related to the degree of association stored in the storage unit. The distributing unit distributes the advertisement information as advertisement information to be distributed to the content when the determining unit determines that the degree of association is within the range.

### CROSS-REFERENCE TO RELATED APPLICATIONS

The present application claims priority to and incorporates by reference the entire contents of Japanese Patent Application No. 2012-242870 filed in Japan on Nov. 2, 2012.

### BACKGROUND OF THE INVENTION

1. Field of the Invention

The present invention relates to an advertisement distribution apparatus and an advertisement distribution method.

2. Description of the Related Art

In recent years, with the rapid spread of the Internet, the distribution of advertisements through the Internet has been actively performed. As an example of a method of distributing advertisements, a method of displaying a text advertisement indicating a company or a product at a predetermined position of content (for example, a web page) and allowing a user to move to a web page of an advertiser by clicking on the text advertisement has been known.

As above, as a method of selecting an advertisement displayed within content, a so-called content match advertisement that displays an advertisement corresponding to the content has been known (for example, see Japanese Laid-open Patent Publication No. 2007-286833). For example, in the content match advertisement, an advertisement is compared with the content to calculate degree of association indicating the degree of association between the advertisement and the content, and when the calculated degree of association is equal to or larger than a preset value related to degree of association, the advertisement is displayed within the content as an advertisement that is related to the content. The preset value related to degree of association is a value that is set on an advertisement distribution apparatus that distributes an advertisement.

However, in the content match advertisement technique, since the value related to degree of association is set by the advertisement distribution apparatus, an advertiser cannot select the value related to degree of association and thus, a case where an advertisement is displayed within a content unintended by the advertiser may occur. Thus, there are problems in that an appropriate advertising effect is not obtained and that the user viewing the content may feel that an advertisement that does not match the content is distributed.

That is, as a general use case of advertisement distribution, a wide range of candidates for advertisements that can be distributed are acquired, and values related to degree of association are set so as to secure a profit without causing such opportunity loss that the number of advertisements to be distributed decreases. Thus, although the content match advertisement is a method of displaying advertisements related to the content, this method does not allow the advertiser to control the degree of association and actually distributes advertisements having degree of associations equal to or larger than a predetermined constant value determined by the advertisement distribution apparatus. Therefore, for example, there is a case where an advertisement page (for example, a page that is related in its broader sense but is not considered by the advertiser to be relevant) that is beyond the advertiser's expectation or an advertisement that does not match the content for the user viewing the content is distributed. As a result, there is a problem in that the above technique is not contributable to improvement and propagation of network advertising in the long term.

Moreover, for example, although the advertisement distribution apparatus may set a high value related to degree of association to the advertisement, if the value related to degree of association is high, the number of advertisements that can be distributed decreases. On the other hand, there is a problem in that it is difficult to meet the needs of advertisers who want advertisements to be displayed in a wide range of contents even if the degree of association is not so high.

### SUMMARY OF THE INVENTION

It is an object of the present application to at least partially solve the problems in the conventional technology.

According to one aspect of an embodiment, an advertisement distribution apparatus includes: a storage unit configured to store a value related to a degree of association with content to which advertisement information is allowed to be distributed; a calculating unit configured to calculate a degree of association between content and advertisement information upon receiving a distribution request for advertisement information to be distributed to the content; a determining unit configured to determine whether the degree of association calculated by the calculating unit is within a range determined by the value related to the degree of association stored in the storage unit; and a distributing unit configured to distribute the advertisement information as advertisement information to be distributed to the content when the determining unit determines that the degree of association is within the range.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a block diagram illustrating a configuration of an advertisement distribution system according to a first embodiment;

FIG. 2 is a block diagram illustrating a configuration of an advertisement distribution apparatus according to the first embodiment;

FIG. 3 is a diagram illustrating an example of an advertisement table;

FIG. 4 is a diagram illustrating an example of a bid table;

FIG. 5 is a diagram illustrating an example of an advertiser table;

FIG. 6 is a diagram illustrating an example of a degree of association designation screen during bidding;

FIG. 7 is a diagram for describing an example of bidding according to a degree of association;

FIG. 8 is a diagram for describing an example of a process of extracting characteristic words;

FIG. 9 is a diagram for describing processes of calculating and determining degree of associations;

FIG. 10 is a diagram illustrating an example of a display screen of a content in which an advertisement is inserted;

FIG. 11 is a flowchart illustrating a bid receiving process of the advertisement distribution apparatus according to the first embodiment;

FIG. 12 is a sequence diagram illustrating an advertisement distributing process of the advertisement distribution apparatus according to the first embodiment;

FIG. 13 is a diagram for describing a process of automatically sorting bidding prices; and

FIG. 14 is a diagram illustrating an example of a degree of association designation screen during bidding.

### DETAILED DESCRIPTION OF THE PREFERRED EMBODIMENTS

Hereinafter, an advertisement distribution apparatus and an advertisement distribution method according to an exemplary embodiment (hereinafter referred to as an “embodiment”) of this application will be described in detail with reference to the accompanying drawings. The advertisement distribution apparatus and the advertisement distribution method according to the application are not limited to the embodiment.

### First Embodiment

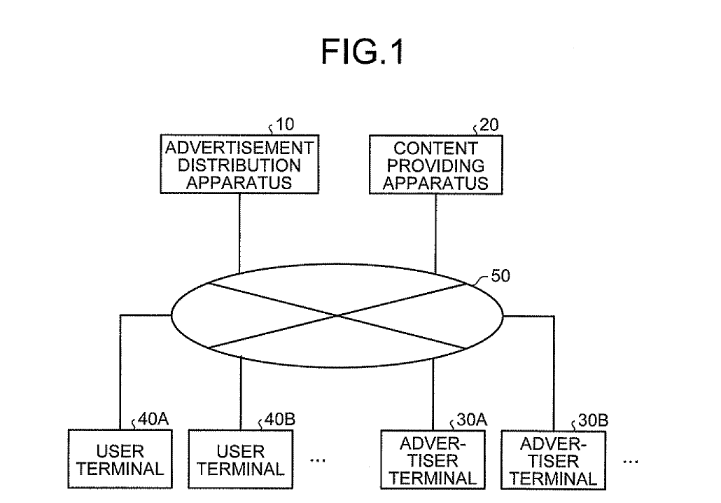

A first embodiment of an advertisement distribution apparatus and an advertisement distribution method according to the application will be described with reference FIGS. 1 to 12.

### Configuration of Advertisement Distribution System

First, a configuration of an advertisement distribution system including an advertisement distribution apparatus 10 according to the first embodiment will be described with reference to FIG. 1. FIG. 1 is a block diagram illustrating the configuration of an advertisement distribution system according to the first embodiment.

As illustrated in FIG. 1, the advertisement distribution system according to the first embodiment includes the advertisement distribution apparatus 10, a content providing apparatus 20, a plurality of advertiser terminals 30A and 30B, and a plurality of user terminals 40A and 40B. The advertisement distribution apparatus 10, the content providing apparatus 20, the plurality of advertiser terminals 30A and 30B, and the plurality of user terminals 40A and 40B perform radio communication or cable communication via a network 50. The advertiser terminals 30A and 30B and the user terminals 40A and 40B will be referred to as an advertiser terminal 30 and a user terminal 40 when they are described without being distinguished from each other.

The advertisement distribution apparatus 10 receives bids and submissions for advertisements from the plurality of advertiser terminals 30A and 30B and receives a value related to degree of association with contents to which an advertisement is okay to be distributed. Moreover, upon receiving a request to distribute an advertisement to be embedded in contents from the content providing apparatus 20, the advertisement distribution apparatus 10 acquires the advertisement to be embedded in the content based on the degree of association designated from the advertiser terminal 30 and distributes the acquired advertisement to the content providing apparatus 20.

The content providing apparatus 20 provides contents according to a content acquisition request from the user terminal 40, and for example, provides a web page browsing service or the like. For example, when a web page browsing request is received from the user terminal 40, the content providing apparatus 20 acquires advertisement information related to the content of the web page from the advertisement distribution apparatus 10, adds the acquired advertisement information to HTML data of the web page, and transmits the HTML data of the web page to the user terminals 40A and 40B. When the user terminal 40 sends the content acquisition request to the content providing apparatus 20, the content acquisition request may be redirected to the advertisement distribution apparatus 10 so that an advertisement is directly distributed from the advertisement distribution apparatus 10 to an advertisement frame of the contents displayed to the user terminal 40.

The plurality of advertiser terminals 30A and 30B are the terminal of an advertiser that sets an advertisement distributed by the advertisement distribution apparatus 10. Specifically, the advertiser terminals 30A and 30B notify the advertisement distribution apparatus 10 of settings of bidding prices, submissions for advertisements, settings of degree of associations with contents to which an advertisement is okay to be distributed, and the like according to the operations of the advertisers.

The plurality of user terminals 40A and 40B are a terminal that accesses the content providing apparatus 20 according to the user's operation, acquires hyper text markup language (HTML) data or the like of a web page, and outputs the web page to a display.

### Configuration of Advertisement Distribution Apparatus

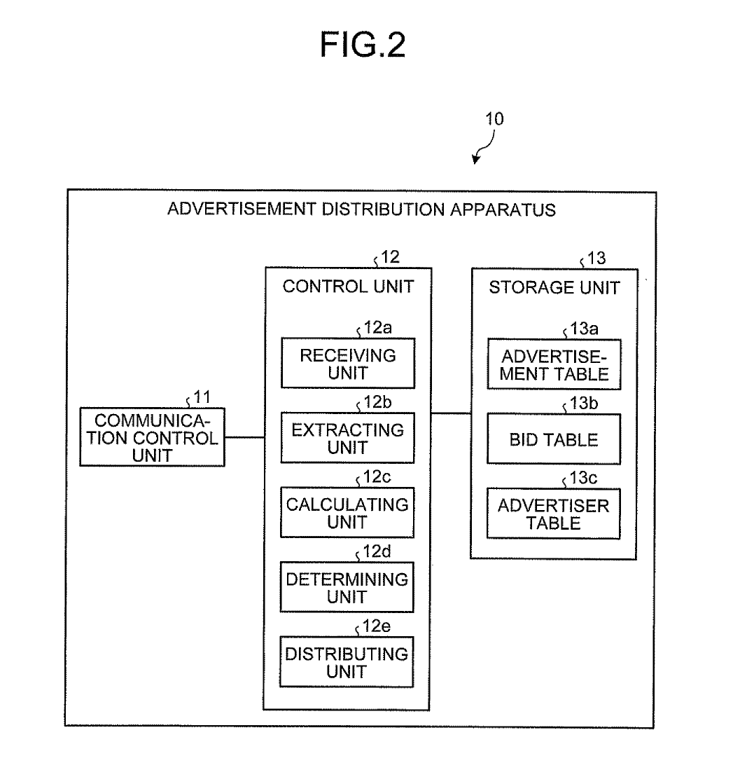

Next, the configuration of the advertisement distribution apparatus 10 will be described with reference to FIG. 2. FIG. 2 is a block diagram illustrating a configuration of the advertisement distribution apparatus according to the first embodiment. The advertisement distribution apparatus 10 includes a communication control unit 11, a control unit 12, and a storage unit 13.

The communication control unit 11 transmits and receives various types of data to and from the content providing apparatus 20, the plurality of advertiser terminals 30A and 30B, and the plurality of user terminals 40A and 40B via the network 50. The communication control unit 11 corresponds to a network card (NIC), for example.

The storage unit 13 is a semiconductor memory device such as a random access memory (RAM) or a flash memory or a storage device such as a hard disk or an optical disc, for example. The storage unit 13 stores an advertisement table 13a, a bid table 13b, and an advertiser table 13c.

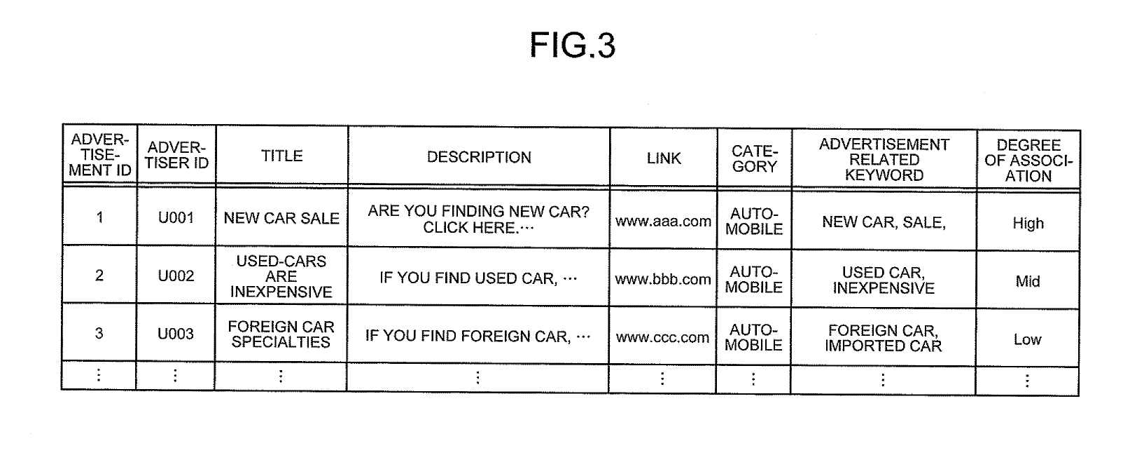

The advertisement table 13a stores information related to advertisements. For example, as illustrated in FIG. 3, “advertisement ID” which is an identifier for identifying an advertisement, “advertiser ID” which is an identifier for identifying an advertiser that submits a request for an advertisement, “title” and “description” displayed as a sentence related to an advertisement, “link” which is the URL of a link set to a displayed advertisement, “category” indicating the category of an advertisement, “advertisement related keyword” which is a keyword related to an advertisement, and “degree of association” which is a value related to degree of association for determining contents to which an advertisement is okay to be distributed are stored in the advertisement table 13a in correlation. In the following description, although a case where a value related to degree of association is stored for each advertisement is described, the application is not limited to this. For example, the value related to degree of association may be stored for each advertiser and the value related to degree of association may be stored for each advertisement campaign.

A specific example of FIG. 3 will be described. In the advertisement table 13a, an advertisement ID “1”, an advertiser ID “U001”, a title “New Car Release”, a description “Are you finding a new car? Click Here . . . ”, a link “www.aaa.com”, a category “automobile”, an advertisement related keyword “New Car, Sale, . . . ”, and a degree of association “High” are stored in correlation. The “advertisement ID”, “advertiser ID”, “title”, “description”, “link”, “category”, “advertisement related keyword” and “degree of association” are registered whenever submissions for advertisements are received from the advertiser terminal 30.

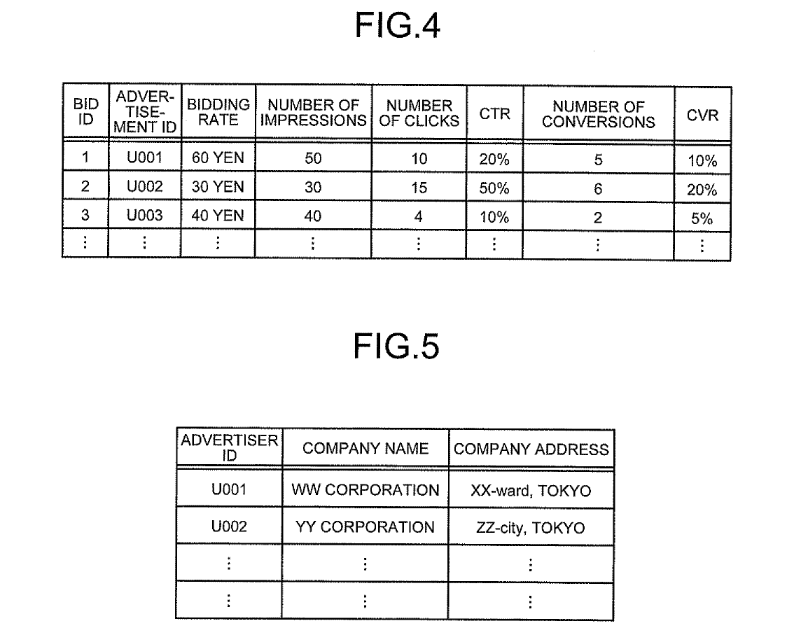

The bid table 13b stores information related to conditions for displaying advertisements. For example, as illustrated in FIG. 4, “bid ID” which is an identifier for identifying a bid, “advertisement ID” which is an identifier for identifying an advertisement for bidding, “bidding price” indicating a bidding price serving as a reference amount of money charged per click, “number of displays (number of impressions (Imps))” which is the number of times an advertisement is displayed, “number of clicks” which is the number of clicks on an advertisement banner, “CTR (number of clicks/Imps)” indicating the percentage of clicks to the number of times the advertisement was displayed, “number of conversions” indicating the number of times an advertisement results in a conversion (a final result obtainable from contents such as a purchase of a product or a request for material), and “conversion rate (CVR)” indicating the percentage of conversions to the number of distributions of advertisement are stored in the bid table 13b in correlation. The advertisement table 13a and the bid table 13b may be combined into one table.

A specific example of FIG. 4 will be described. In the bid table 13b, a bid ID “1”, an advertiser ID “U001”, a bidding rate “60 Yen”, the number of impressions “50”, the number of clicks “10”, a CTR “20%”, the number of conversions “5”, and a CVR “10%” are stored in correlation. The “bid ID”, “advertiser ID”, and “bidding rate” are registered whenever a request for bidding for advertisements is received from the advertiser terminal 30, and the “number of impressions”, “number of clicks”, “CTR”, “number of conversions”, and “CVR” are updated whenever advertisements are distributed.

The advertiser table 13c stores information on advertisers. For example, as illustrated in FIG. 5, “advertiser ID”, “company name” indicating the name of a company that submits a request for an advertisement, and “company address” indicating the location of the company are stored in the advertiser table 13c in correlation. A specific example of FIG. 5 will be described. In the advertiser table 13c, an advertiser ID “U001”, a company name “WW Corporation”, and a company address “XX-ward, Tokyo” are stored in correlation. The “advertiser ID”, “company name”, and “company address” are registered whenever an advertiser bids for advertisements for the first time.

The control unit 12 includes a receiving unit 12a, an extracting unit 12b, a calculating unit 12c, a determining unit 12d, and a distributing unit 12e. The control unit 12 is realized when a CPU or an MPU operates according to a computer program stored in advance in a storage device.

The receiving unit 12a receives settings of bidding prices, submissions for advertisements, and settings of degree of associations with contents to which an advertisement is okay to be distributed from the advertiser terminal 30.

Specifically, upon receiving an advertisement bidding request from the advertiser terminal 30, first, the receiving unit 12a receives an input of basic advertiser information as initial settings and stores the information in the advertiser table 13c. The basic advertiser information is formal information such as a company name or a company address, for example. If the basic advertiser information has been input in the past and registered, the input of the basic advertiser information may be omitted.

Subsequently, the receiving unit 12a receives the amount of bidding price which is the amount of money paid per click on an advertisement banner from the advertiser terminal 30 as a bidding rate for an advertisement and stores the bidding price in the bid table 13b.

For example, when an advertiser sets a total budget to ¥10000 and bids ¥100 as a click charge, ¥100 is paid to a system operator for each click of an advertisement, and the distribution of the advertisement is stopped when the advertisement is clicked 100 times and the payment amount reaches ¥10000 which is the budget amount.

Subsequently, the receiving unit 12a receives a title and a description displayed as an advertisement, a category indicating the category of the advertisement, an advertisement related keyword which is a keyword related to the advertisement, and the URL of a link set to the advertisement displayed in the contents as a submission for the advertisement and stores in the advertisement table 13a. For example, the advertiser inputs a catchphrase as a title of the advertisement and inputs a description of a product or a service as the description. Moreover, the advertiser inputs the URL of a web site to which the user moves when the advertisement displayed as a link is clicked on. Advertisements that an advertiser wants to distribute are examined, and distribution of advertisements starts after the advertisements pass the examination.

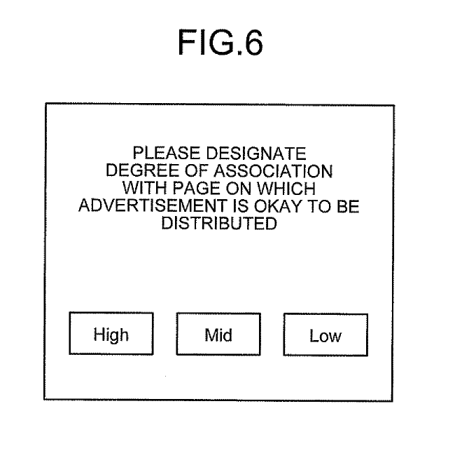

After that, the receiving unit 12a receives the input of degree of associations from the advertiser terminal 30. For example, in order to receive the input of degree of associations from the advertiser terminal 30, the receiving unit 12a displays a message “Please designate a degree of association with a page on which an advertisement is okay to be distributed” on a screen of the advertiser terminal 30, as illustrated in FIG. 6 and allows the advertiser to select one of the degree of associations “High”, “Mid”, and “Low” displayed on the screen.

Moreover, upon receiving the selection of degree of association, the receiving unit 12a stores the degree of association in the advertisement table 13a in association with the advertisement information. Here, it is assumed, for example, that the degree of association is “90%” for “High”, “70%” for “Mid”, and “50%” for “Low”. The degree of associations corresponding to “High”, “Mid”, and “Low” can be changed optionally.

For example, the advertiser may select the degree of association “High” when the advertiser wants an advertisement to be distributed to contents when the advertisement and the contents are closely related and may select the degree of association “Low” when the advertiser wants an advertisement to be distributed to various contents even when the advertisement and the contents are not closely related. The timing at which the degree of association is set is not limited to when the advertiser submits a request for advertisements.

In this manner, since the advertiser can designate the degree of association with a page on which an advertisement is okay to be distributed when the advertiser submits a request for the advertisements, the advertiser can use various methods of submitting a request for advertisement based on his/her own advertising strategy. For example, as an example of advertising strategy, the advertiser can freely submit requests for advertisements in such a manner to set a high bidding price to High degree of association to go for conversion or to set a low bidding price to Low degree of association to expect an advertisement to be distributed to a wide range of contents.

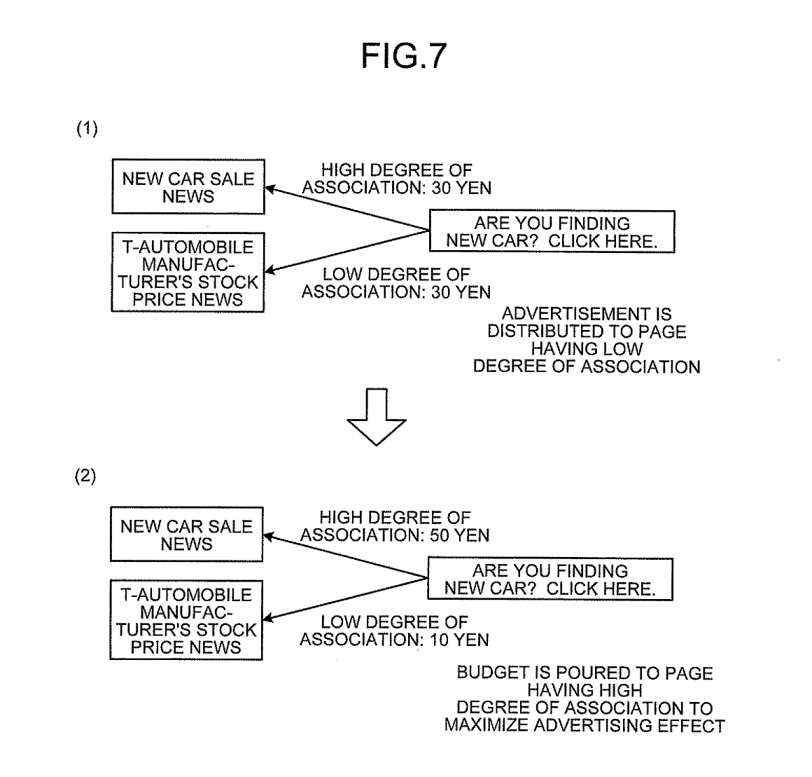

Here, a difference in bidding between the related art and the invention will be described with reference to FIG. 7. FIG. 7 is a diagram for describing an example of bidding according to a degree of association. FIG. 7(1) illustrates an example of a conventional bidding method in which an advertiser cannot select a degree of association, and FIG. 7(2) illustrates an example of a bidding method of the advertisement distribution apparatus 10 in which an advertiser can select a degree of association.

For example, in the example of the conventional bidding method illustrated in FIG. 7(1), the degree of association is set by the advertisement distribution apparatus, and the advertiser cannot set a degree of association for each advertisement. Moreover, a constant bidding price (bidding price “30 Yen” in the example of FIG. 7(1)) is set to the advertisement. Thus, if a degree of association exceeds the degree of association set by the advertisement distribution apparatus, there is a case where a web page that the advertiser considers to have a low degree of association with an advertisement and that the advertiser does not want an advertisement to be distributed to is distributed to the advertisement.

On the other hand, for example, in the example of the bidding method of the advertisement distribution apparatus 10 illustrated in of FIG. 7(2), an advertiser can use an advertising strategy for an advertisement “Are you finding a new car? Click Here.” in such a manner that a high bidding price “50 Yen” is set to the degree of association “High” that allows distribution when the degree of association is high to go for conversion. On the other hand, when a low bidding price “10 Yen” is set to the degree of association “Low” that allows distribution even when the degree of association is low, the advertiser pours budget to a web page having a high degree of association so that an advertisement is distributed with a high probability to a web page having a high degree of association to thereby obtain the maximum advertising effect.

Upon receiving a request to distribute advertisements to contents from the content providing apparatus 20, the extracting unit 12b extracts characteristic words from the text information (for example, HTML data) included in the contents. Specifically, upon receiving HTML data of a web page on which an advertiser wants an advertisement to be posted from the content providing apparatus 20, the extracting unit 12b extracts characteristic words from the HTML data using an existing characteristic extraction algorithm such as “tf-idf”.

Hereinafter, an example of a characteristic word extraction process will be described in detail. For example, the extracting unit 12b extracts words included in the HTML data and calculates a weight for each word. The weight is a value indicating the degree of association between the word and web contents and is calculated based on basic elements for degree of association calculation (for example, occurrence frequency of words in web contents, occurrence position, character attribute (font data), or the like). A word having high occurrence frequency within the web contents has a meaning that directly characterizes the web contents, and a word appearing at the location of the web contents corresponding to the title or appearing in the first half of a document has a meaning that abstractively characterizes the web contents. Moreover, since a creator of the web contents assigns the character attribute (font size, bold, underline, color, or the like) to a word with a certain intention, the character attribute is similarly considered to have a meaning that characterizes the web contents.

Moreover, how often a word is used in the world in general may be taken into consideration when calculating the weight. A weight may be simply increased according to the number of hits when a word is retrieved using a search engine, and a higher weight may be similarly assigned to a proper noun than a general noun (common noun) by assuming that a proper noun has higher degree of association to a product name or the like than a common noun.

As an example related to weighting, TF-IDF which is an algorithm (natural language processing) for extracting characteristic words in a sentence is known. A TF-IDF value is obtained from a TF value indicating the occurrence frequency of a word obtained from contents and a DF value which is the occurrence frequency obtained as a result of retrieving a corpus (or an IDF value which is inverse occurrence frequency), and characteristic words are extracted by selecting characteristic words of which the TF-IDF value is equal to or larger than a threshold value as the characteristic words. The corpus is the same as a database that includes a number of words, in which each word and the occurrence frequency (DF value) of the each word is stored. This algorithm has a role of decreasing a weight of general words that appear in many documents while increasing a weight of words that appear in specific documents only. For example, characteristic words may be extracted according to such conditions that “all words of which the TF-IDF value is equal to or larger than a predetermined threshold value are extracted” or “the top-N words of which the TF-IDF value is equal to or larger than the predetermined threshold value are extracted”. In this manner, words that will be extracted as characteristic words can be determined flexibly.

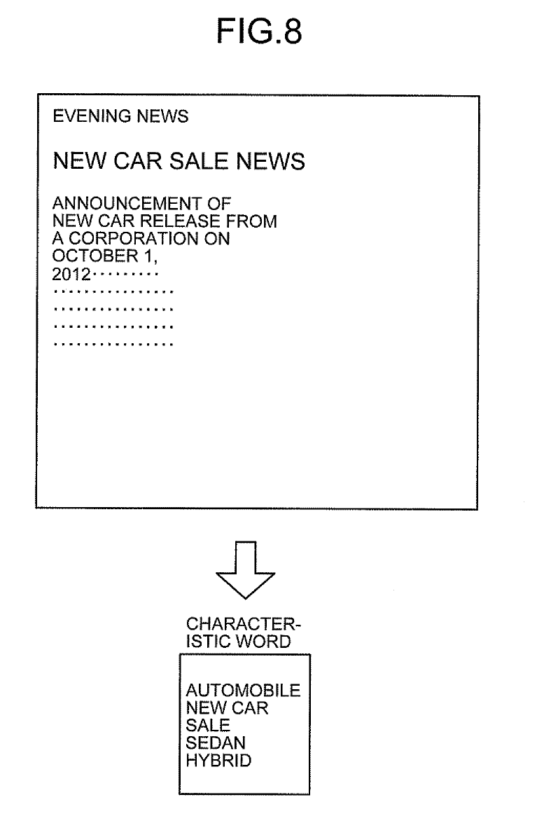

Here, the process of extracting characteristic words will be described with reference to a specific example of FIG. 8. FIG. 8 is a diagram for describing an example of a characteristic word extracting process. For example, as illustrated in FIG. 8, when web contents include a title “News related to Release of New Car” and a body “Announcement of New Car Release from A Corporation on Oct. 1, 2012 . . . ”, words included in the HTML data of the web contents are extracted, and the TF-IDF value is calculated for each word. Moreover, the top-5 words having the higher TF-IDF value “automobile”, “new car”, “sale”, “sedan”, and “hybrid” are extracted as the characteristic words.

The calculating unit 12c compares the characteristic words extracted by the extracting unit 12b with the advertisement related keywords of each advertisement and calculates a degree of association between each item of the advertisement information and the contents. For example, the calculating unit 12c compares the characteristic words extracted by the extracting unit 12b with the advertisement related keywords of the advertisement information and calculates a percentage of the number of characteristic words identical to the advertisement related keywords to the total number of characteristic words as a degree of association. This process of calculating the degree of association is performed for each item of advertisement information to obtain the degree of association of each item of advertisement information of the contents.

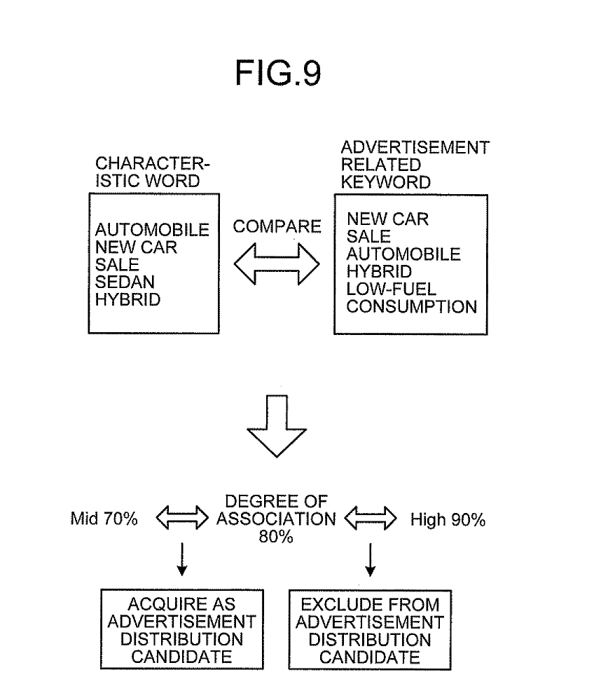

Here, an example of the degree of association calculating process will be described with reference to FIG. 9. For example, as illustrated in FIG. 9, five characteristic words “automobile”, “new car”, “sale”, “sedan”, and “hybrid” are compared with five advertisement related keywords “new car”, “sale”, “automobile”, “hybrid”, and “low-fuel consumption”. As a result, since four characteristic words “automobile”, “new car”, “sale”, and “hybrid” among the total number “5” of characteristic words are identical to the advertisement related keywords, the degree of association is calculated as “80%”.

The determining unit 12d determines whether the degree of association of each item of advertisement information calculated by the calculating unit 12c is larger than the degree of association corresponding to each item of advertisement information stored in the advertisement table 13a. This will be described with reference to the example of FIG. 9, for example. When the calculated degree of association is “80%” and the degree of association stored in the advertisement table 13a is “High” (that is, the degree of association is “90%”), the determining unit 12d determines that the calculated degree of association “80%” is lower than the degree of association “90%” stored in the advertisement table 13a and excludes the advertisement from advertisement distribution candidates. On the other hand, when the calculated degree of association is “80%” and the degree of association stored in the advertisement table 13a is “Mid” (that is, the degree of association stored in the advertisement table 13a is “70%”), the determining unit 12d determines that the calculated degree of association “80%” is higher than the degree of association “70%” stored in the advertisement table 13a and acquires the information on the advertisement as an advertisement distribution candidate.

The distributing unit 12e acquires any one of the items of advertisement information of which the calculated degree of association is determined to be larger than the degree of association stored in the advertisement table 13a and distributes the advertisement information to the content providing apparatus 20. For example, when there are a number of items of advertisement information of which the calculated degree of association is determined to be larger than the degree of association stored in the advertisement table 13a, the distributing unit 12e compares the values of the product of “bidding rate” and “click trough rate (CTR)” of respective items of advertisement information, selects advertisement information having the higher value of the product of “bidding rate” and “click through rate”, and distributes the advertisement information to the content providing apparatus 20.

In this manner, an advertiser can designate a degree of association with a page on which an advertisement is okay to be distributed when the advertiser submits a request for the advertisement, it can prevent the advertisement from being posted on a page that the advertiser does not consider to be related by setting a high degree of association to the advertisement. On the other hand, it is possible to meet the needs of an advertiser who wants an advertisement to be distributed to a wide range of contents by setting a low degree of association to the advertisement.

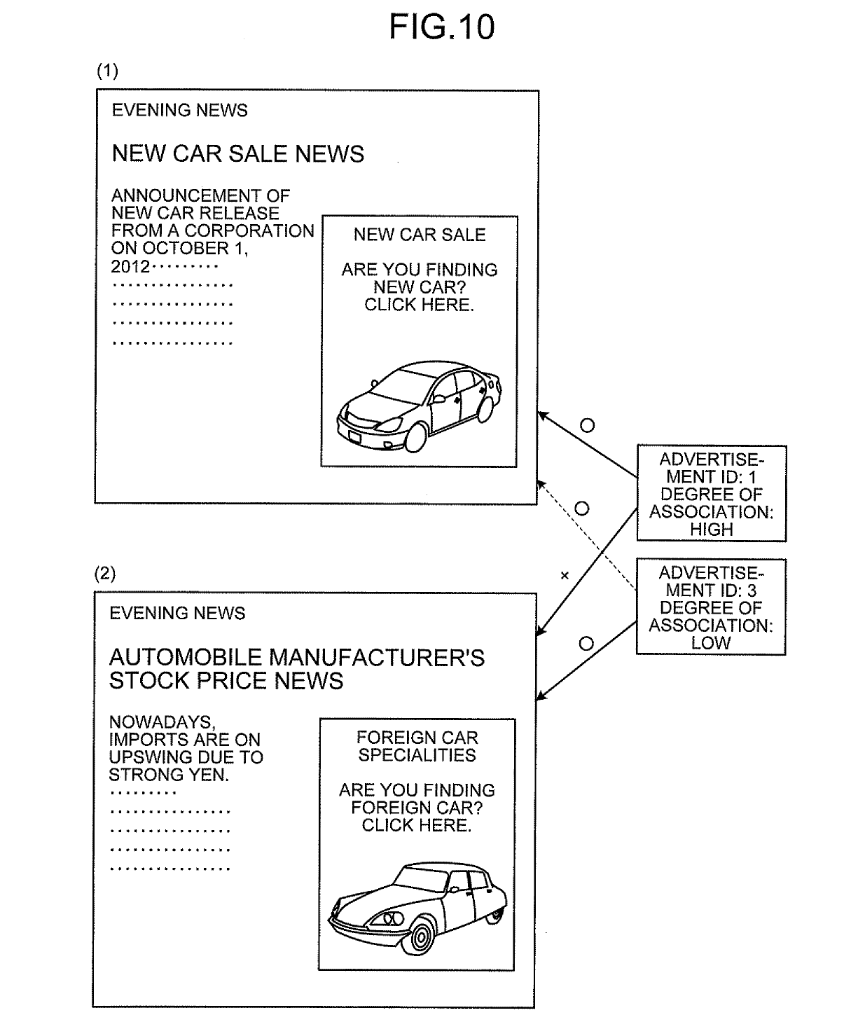

For example, as illustrated in FIG. 10, since the degree of association is set to “High” for the advertisement ID “1” (see FIG. 3), although an advertisement is distributed to only “New Car Sale News” having high degree of association, “Automobile Manufacturer's Stock Price News” having low degree of association is excluded from advertisement distribution targets. Moreover, since the degree of association is set to “Low” for the advertisement ID “3” (see FIG. 3), the advertisement is distributed to “Automobile Manufacturer's Stock Price News” having low degree of association as well as “New Car Sale News” having high degree of association. Although “New Car Sale News” becomes an advertisement distribution candidate for both the advertisement information of the advertisement ID “1” and the advertisement information of the advertisement ID “3”, in this example, the advertisement information of the advertisement ID “1” of which a high bidding price is set is distributed.

### Process of Advertisement Distribution Apparatus

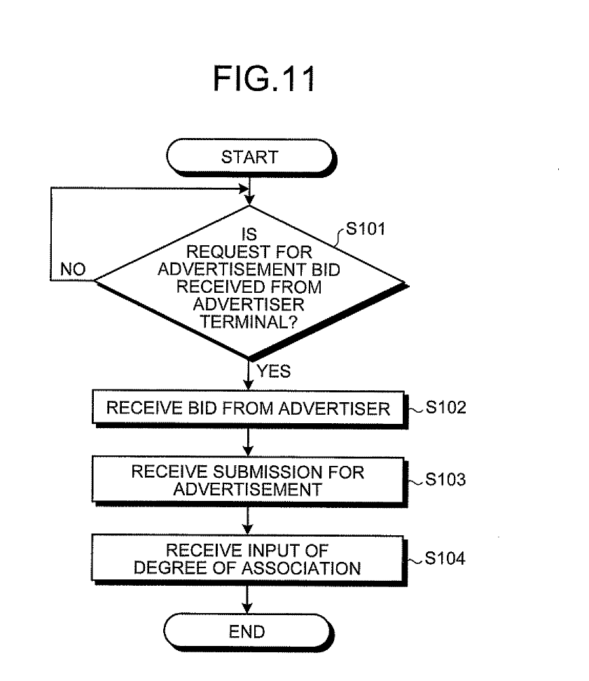

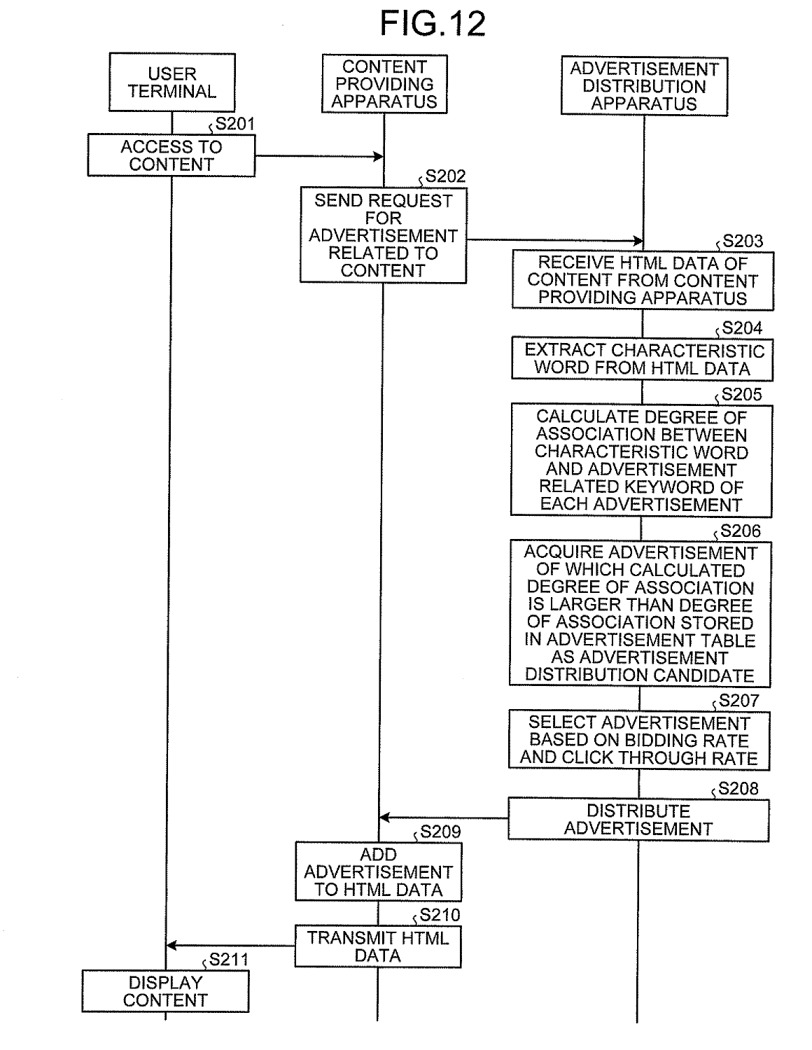

Next, the process of the advertisement distribution apparatus 10 according to the first embodiment will be described with reference to FIGS. 11 and 12. FIG. 11 is a flowchart illustrating a bid receiving process of the advertisement distribution apparatus according to the first embodiment. FIG. 12 is a sequence diagram illustrating an advertisement distributing process of the advertisement distribution apparatus according to the first embodiment.

As illustrated in FIG. 11, upon receiving a request for bidding for advertisements from the advertiser terminal 30 (step S101: Yes), the receiving unit 12a of the advertisement distribution apparatus 10 receives a bid from the advertiser terminal 30 (step S102). Specifically, the receiving unit 12a receives the amount of click charge which is the amount of money paid per click on an advertisement banner from the advertiser terminal 30 as a bidding rate for an advertisement and stores the bidding rate in the bid table 13b.

For example, when an advertiser sets a total budget to ¥10000 and bids ¥100 as a click charge, ¥100 is paid to a system operator for each click of an advertisement, and the distribution of the advertisement is stopped when the advertisement is clicked 100 times and the payment amount reaches ¥10000 which is the budget amount.

Subsequently, the receiving unit 12a receives submissions for advertisements from the advertiser terminal 30 (step S103). Specifically, the receiving unit 12a receives a title and a description displayed as an advertisement and the URL of a link set to the displayed advertisement as a submission for the advertisement and stores the request for the advertisement in the advertisement table 13a. For example, the advertiser inputs a catchphrase as the title of the advertisement and inputs a description of a product or a service as the description. Moreover, the advertiser inputs the URL of a web site to which the user moves when the advertisement displayed as a link is clicked on.

After that, the receiving unit 12a receives the input of a degree of association from the advertiser terminal 30 (step S104). For example, in order to receive the input of degree of associations from the advertiser terminal 30, the receiving unit 12a displays a message “Please designate a degree of association with a page on which an advertisement is okay to be distributed” on a screen of the advertiser terminal 30, as illustrated in FIG. 6 and allows the advertiser to select one of the degree of associations “High”, “Mid”, and “Low” displayed on the screen. Moreover, upon receiving the selection of degree of association, the receiving unit 12a stores the degree of association in the advertisement table 13a in association with the advertisement information.

Next, the advertisement distributing process of the advertisement distribution apparatus 10 will be described with reference to FIG. 12. As illustrated in FIG. 12, the user terminal 40 accesses contents provided by the content providing apparatus 20 according to the user's operation (step S201). Subsequently, upon receiving an access to the contents from the user, the content providing apparatus 20 sends a request to the advertisement distribution apparatus 10 to distribute an advertisement related to the contents and transmits the HTML data of a web page to the advertisement distribution apparatus 10 (step S202).

Moreover, upon receiving HTML data of a web page on which an advertiser wants an advertisement to be posted from the content providing apparatus 20 (step S203), the extracting unit 12b of the advertisement distribution apparatus 10 extracts characteristic words from the HTML data using an existing characteristic extraction algorithm such as “tf-idf” (step S204).

The calculating unit 12c of the advertisement distribution apparatus 10 compares the characteristic words extracted by the extracting unit 12b with the advertisement related keywords of each item of advertisement information and calculates a degree of association between each item of the advertisement information and the contents (step S205). For example, the calculating unit 12c compares the characteristic words extracted by the extracting unit 12b with the advertisement related keywords of the advertisement information and calculates a proportion of the number of characteristic words identical to the advertisement related keywords to the total number of characteristic words as a degree of association. This process of calculating the degree of association is performed for each item of advertisement information to obtain the degree of association of each item of advertisement information of the contents.

Subsequently, the determining unit 12d of the advertisement distribution apparatus 10 determines whether the degree of association of each item of advertisement information calculated by the calculating unit 12c is larger than the degree of association corresponding to each item of advertisement information stored in the advertisement table 13a and acquires advertisements of which the calculated degree of association is determined to be larger than the degree of association stored in the advertisement table 13a as advertisement distribution candidates (step S206).

After that, the distributing unit 12e of the advertisement distribution apparatus 10 selects an advertisement among the advertisements of which the calculated degree of association is determined to be larger than the degree of association stored in the advertisement table 13a based on a bidding rate and a click through rate (step S207). Specifically, when there are multiple of items of advertisement information of which the calculated degree of association is determined to be larger than the degree of association stored in the advertisement table 13a, the distributing unit 12e compares the values of the product of “bidding rate” and “click through rate (CTR)” of respective items of advertisement information and selects advertisement information having the higher value of the product of “bidding rate” and “click trough rate”. Moreover, the distributing unit 12e distributes information on the selected advertisement to the content providing apparatus 20 (step S208).

Upon receiving the advertisement information from the advertisement distribution apparatus 10, the content providing apparatus 20 adds the acquired advertisement information to the HTML data of the web page (step S209) and transmits the. HTML data of the web page to the user terminals 40A and 40B (step S210). After that, the user terminal 40 acquires the HTML data and the like of the web page and displays the web page on a display (step S211).

### Effects of First Embodiment

As described above, the advertisement distribution apparatus 10 stores a degree of association with contents to which advertisement information is allowed to be distributed for each item of advertisement information. Moreover, upon receiving a distribution request for advertisement information to be added to contents, the advertisement distribution apparatus 10 calculates a degree of association between the contents and the advertisement information, determines whether the calculated degree of association is larger than a stored degree of association corresponding to the advertisement information, and distributes the advertisement information as advertisement information to be added to the contents when the calculated degree of association is determined to be larger than the stored degree of association corresponding to the advertisement information. In this manner, in the advertisement distribution apparatus 10, a designation of a degree of association between an advertisement and contents is received from an advertiser, the degree of association designated by the advertiser is stored, and the advertisement information to be distributed is selected using the stored degree of association. As a result, the advertiser can use various bidding methods based on the advertiser's advertising strategy to appropriately obtain an advertising effect.

Moreover, the advertisement distribution apparatus 10 extracts characteristic words from text information included in contents to which the advertisement information is added and compares the extracted characteristic words with stored advertisement related keywords corresponding to the advertisement information to calculate the degree of association. Thus, in the advertisement distribution apparatus 10, it is possible to appropriately calculate the degree of association and to appropriately select advertisement information to be distributed using the degree of association designated by the advertiser.

### Second Embodiment

While the first embodiment of the invention has been described, the invention may be implemented in various other embodiments other than the above embodiment. Another embodiment of the invention will be described as a second embodiment.

### (1) Automated Setting of Bidding Price

In the first embodiment described above, although a case where an advertiser sets a bidding price has been described, the invention is not limited to this. The advertisement distribution apparatus may automatically set the bidding price based on cost per action (CPA) corresponding to a degree of association that provides the best effect. Here, CPA means the cost taken to obtain the results of advertisements.

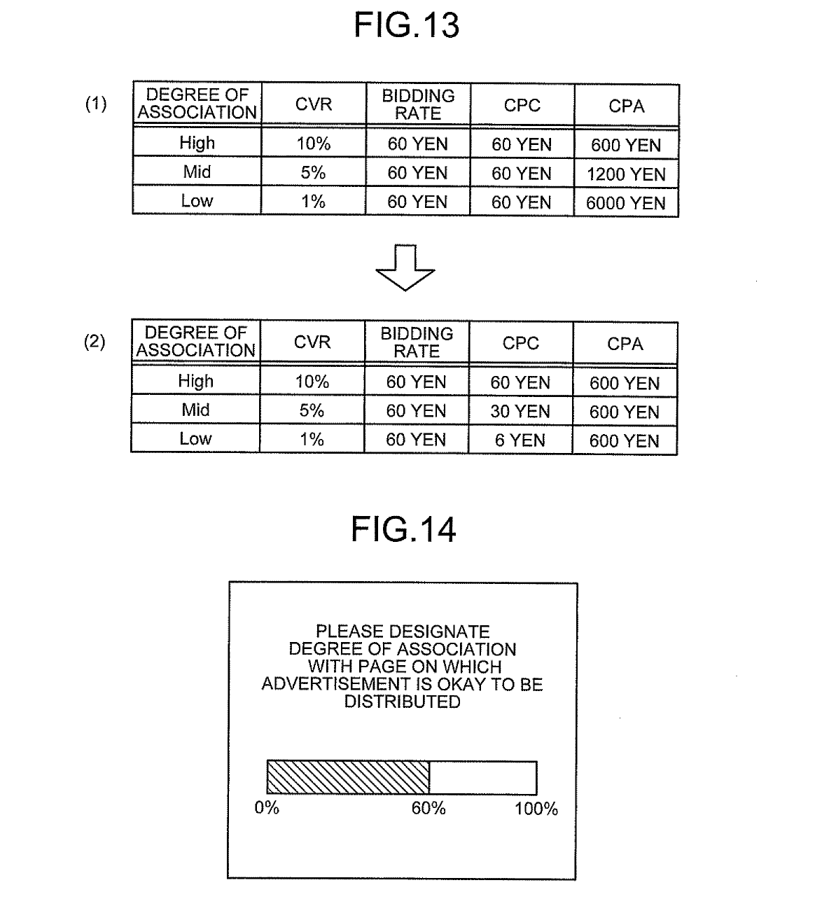

For example, a process in which the advertisement distribution apparatus automatically sets the bidding price will be described with reference to the example of FIG. 13. In the example of FIG. 13(1), “conversion rate (CVR)” indicating the percentage of conversions to the number of distributions of advertisement and “CPA” indicating the amount of money paid per result are registered when degree of associations “High”, “Mid”, and “Low” are set to the same advertisements and “bidding rate” and “cost per click (CPC)” are set to “60 Yen” for the respective advertisements. In this example, “bidding rate” is a bidding price set by the advertiser, and “CPC” is a bidding price that is automatically set by the advertisement distribution apparatus. Since the example of FIG. 13(1) illustrates a state before the bidding price is automatically set by the advertisement distribution apparatus, all degree of associations are set to “60 Yen”.

For example, as illustrated in FIG. 13(1), when the degree of association is “High”, the CVR is “10%”, and the CPA is “600 Yen”. That is, it means that one result is obtained when an advertisement is clicked 10 times, and that a cost of 600 Yen is taken to obtain one result. Moreover, as illustrated in FIG. 13(1), when the degree of association is “Mid”, the CVR is “5%”, and the CPA is “1200 Yen”. Moreover, as illustrated in FIG. 13(1), when the degree of association is “Low”, the CVR is “1%”, and CPA is “6000 Yen”.

Here, the advertisement distribution apparatus selects a CPA that provides the best effect (that is, the lowest CPA) among the CPAs corresponding to the degree of associations as a reference CPA. In the example of FIG. 13(1), since the CPA “600 Yen” of the degree of association “High” is the lowest, the CPA “600 Yen” of the degree of association “High” is selected as a reference. Moreover, the CPCs of the other degree of associations “Mid” and “Low” are calculated and are automatically set so that the CPA becomes “600 Yen”.

For example, the CPC is calculated by multiplying the reference CPA by CVR. In the example of FIG. 13(2), “600 Yen multiplied by 5% equals 30 Yen” is calculated as the CPC of the degree of association “Mid” and “30 Yen” is set to the CPC, and “600 Yen multiplied by 1% equals 6 Yen” is calculated as the CPC of the degree of association “Low” and “6 Yen” is set to the CPC.

In this manner, in the advertisement distribution apparatus, the bidding prices of advertisement information corresponding to other degree of associations are set based on a bidding price of advertisement information corresponding to a degree of association that takes the lowest cost for obtaining the result of the advertisement among respective items of advertisement information having different degree of associations. Thus, it is possible to automatically set the bidding price appropriately.

### (2) Presentation of Tendency of Degree of Associations of Other Advertisements

In the invention, the tendency of degree of associations corresponding to other advertisements of the same category as an advertisement submitted by an advertiser terminal may be presented. For example, when an advertiser tries to submit an advertisement, the degree of associations corresponding to other advertisements of the same category as the advertisement are acquired, and one of the degree of associations “High”, “Mid”, and “Low” appearing most frequently among the acquired degree of association is determined. Moreover, the degree of association appearing most frequently may be presented as the tendency of the degree of associations corresponding to the other advertisements when the advertiser designates a degree of association. Moreover, the degree of associations corresponding to the other advertisements may be averaged, and the average value may be presented as the tendency of the degree of associations corresponding to the other advertisements.

In this manner, in the advertisement distribution apparatus, the degree of associations corresponding to other advertisements of the same category as an advertisement that is submitted by an advertiser terminal are counted, and the tendency of the degree of associations corresponding to the other advertisements is presented to the advertiser terminal. Thus, the advertiser can determine the degree of association with reference to the tendency of the degree of associations corresponding to the other advertisements of the same category.

### (3) Setting Using Slide Bar

In the first embodiment, although a case where an advertiser selects one of the degree of associations “High”, “Mid”, and “Low” has been described, the invention is not limited to this. The advertiser may input an optional value related to degree of association or select an optional value related to degree of association using a slide bar.

For example, as illustrated in FIG. 14, the advertisement distribution apparatus displays a message “Please designate degree of association with a page on which advertisement is okay to be distributed” to the advertiser terminal, displays a slide bar to allow the advertiser to select a desired value related to degree of association using the slide bar, and receives the value related to degree of association.

In this manner, a designation of a value related to degree of association is received using the slide bar displayed on the advertiser terminal. Thus, the advertiser can finely set the value related to degree of association using the slide bar.

### (4) Determining Process

In the first embodiment described above, although a case where a process of determining whether the calculated degree of association of each item of advertisement information is larger than the degree of association corresponding to each item of advertisement information stored in the storage unit is performed as the process of determining whether or not to distribute an advertisement, the application is not limited to this. For example, a predetermined range (for example, 50 to 70) may be stored in a storage unit as a degree of association corresponding to advertisement information, and it may be determined whether the calculated degree of association of each item of advertisement information is within the range determined by the degree of association corresponding to each item of advertisement information stored in the storage unit. Besides this, it may be determined whether a reciprocal of the degree of association corresponding to each item of advertisement information is equal to or smaller than a value related to degree of association.

### (5) Others

The advertisement distribution apparatus 10 described above may be realized as a plurality of server computers, and the configuration of the advertisement distribution apparatus 10 may be flexibly changed depending on functions. For example, an external platform may be called by an application programming interface (API) or network computing and then implemented.

In the claims, “unit” may be replaced with “section”, “module”, “unit” or “circuit”. For example, an extractor may be replaced with an extracting unit or an extracting circuit.

According to the advertisement distribution apparatus and the advertisement distribution method according to the aspects of the invention, it is possible to appropriately obtain advertising effects by allowing an advertiser to designate values related to degree of association between advertisements and contents.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement distribution apparatus comprising:
a storage unit configured to store a value related to a degree of association with content to which advertisement information is allowed to be distributed;
a calculating unit configured to calculate the degree of association between content and advertisement information upon receiving a distribution request for advertisement information to be distributed to the content;
a determining unit configured to determine whether the degree of association calculated by the calculating unit is within a range determined by the value related to the degree of association stored in the storage unit; and
a distributing unit configured to distribute the advertisement information as advertisement information to be distributed to the content when the determining unit determines that the degree of association is within the range.

2. The advertisement distribution apparatus according to claim 1, wherein
the storage unit further configured to store a related word which is a word related to advertisement information corresponding to the value related to the degree of association,
the advertisement distribution apparatus further comprises an extracting unit configured to extract a characteristic word from text information included the content to which the advertisement information is distributed, and
the calculating unit compares the characteristic word extracted by the extracting unit and the related word corresponding to the advertisement information stored in the storage to calculate the degree of association.

3. The advertisement distribution apparatus according to claim 1, further comprising:
a setting unit configured to set a bidding price of advertisement information corresponding to other values related to the degree of association based on a bidding price of advertisement information corresponding to the value related to degree of association that takes the smallest cost for obtaining a result of an advertisement among items of advertisement information having different values related to the degree of association.

4. The advertisement distribution apparatus according to claim 1, wherein
the calculating unit further configured to count the values related to the degree of association corresponding to other advertisements of the same category as an advertisement submitted by an advertiser terminal,
the distributing unit further configured to present the tendency of the value related to the degree of association corresponding to the other advertisements to the advertiser terminal.

5. The advertisement distribution apparatus according to claim 1, further comprising:
a receiving unit configured to receive a designation of the value related to the degree of association using a slide bar displayed on an advertiser terminal.

6. An advertisement distribution method executed in an advertisement distribution apparatus, which includes a storage unit configured to store a value related to degree of association with content to which advertisement information is allowed to be distributed, the method comprising:
calculating a degree of association between content and advertisement information upon receiving a distribution request for advertisement information to be distributed to the content;
determining whether the calculated degree of association calculated in the calculating is within a range determined by the value related to the degree of association stored in the storage unit; and
distributing the advertisement information as advertisement information to be distributed to the content when it is determined in the determining step that the degree of association is within the range.

7. The advertisement distribution method according to claim 6, wherein the storage unit further configured to store a related word which is a word related to advertisement information corresponding to the value related to the degree of association,
the method further comprising:
extracting a characteristic word from text information included the content to which the advertisement information is distributed, wherein
the calculating includes calculating the degree of association by comparing the characteristic word extracted by the extracting unit and the related word corresponding to the advertisement information stored in the storage.

8. The advertisement distribution method according to claim 6, further comprising:
setting a bidding price of advertisement information corresponding to other values related to the degree of association based on a bidding price of advertisement information corresponding to the value related to degree of association that takes the smallest cost for obtaining a result of an advertisement among items of advertisement information having different values related to the degree of association.

9. The advertisement distribution method according to claim 6, wherein
the calculating further includes counting the values related to the degree of association corresponding to other advertisements of the same category as an advertisement submitted by an advertiser terminal,
the distributing further includes presenting the tendency of the value related to the degree of association corresponding to the other advertisements to the advertiser terminal.

10. The advertisement distribution method according to claim 6, further comprising:
receiving a designation of the value related to the degree of association using a slide bar displayed on an advertiser terminal.
